(19) United States
(12) Patent Application Publication
(10) Pub. No.: US 2021/0402693 A1
(43) Pub. Date: Dec. 30, 2021

(54) HEATING LAMP ASSEMBLY

(71) Applicant: Hewlett-Packard Development Company, L.P., Spring, TX (US)

(72) Inventors: Ferran Exquius Berengueras, Sant Cugat del Valles (ES); Emili Sapena Masip, Sant Cugat del Valles (ES); Bernat Poll Crespo, Sant Cugat del Valles (ES)

(73) Assignee: Hewlett-Packard Development Company, L.P., Spring, TX (US)

(21) Appl. No.: 17/251,974

(22) PCT Filed: Mar. 20, 2019
(86) PCT No.: PCT/US2019/023178

§ 371 Date: Dec. 14, 2020

(51) Int. Cl. B29C 64/295; B33Y 30/00; B29C 64/364

(52) U.S. Cl. CPC B29C 64/295; B29C 64/364; B33Y 30/00

(57) ABSTRACT

An additive manufacturing system is provided, comprising a heating lamp assembly to apply heat to a build chamber of the manufacturing system at a higher energy density at a peripheral region of the build chamber relative to a central region of the build chamber, to compensate for heat losses and provide a more uniform temperature across the build chamber.

### BACKGROUND

Additive manufacturing systems are used to manufacture three-dimensional (3D) objects by, for example, utilizing a mechanism for successively delivering a material to a print bed to build up a 3D object. The additive manufacturing process may, for example, include selectively delivering coalescing or fusing agents onto a layer of build material to generate layers of the 3D object. 3D printers may use such a mechanism to additively manufacture 3D objects. The additive manufacturing system may include a plurality of lamps to pre-heat the build material during the build process.

### BRIEF DESCRIPTION OF THE DRAWINGS

FIG. 1 is a diagram of a first example heating lamp assembly according to the present disclosure.

FIG. 2 is a diagram of a second example heating lamp assembly according to the present disclosure.

FIG. 3 is a top view of an example print bed plot of a print test according to the present disclosure.

FIG. 4 a perspective view of the print bed of FIG. 3 with example test components having been built on the print bed.

### DETAILED DESCRIPTION

The present disclosure relates to an additive manufacturing system and a heating lamp assembly for an additive manufacturing system. An example additive manufacturing system includes a build chamber defining a volume in which a build platform supporting one or more printing nozzles is moved vertically while the nozzles are moved horizontally. In some examples, the build chamber may be part of a build unit that is removable from the manufacturing system, and the system is adapted to receive a build unit comprising a build chamber in which three dimensional objects can be built. In one example, the heating lamp assembly includes a plurality of lamps that are positioned over a build chamber of an additive manufacturing system, to apply heat to build material within the build chamber, including material within a printing zone that comprises the top layer of build material. In one example, material is iteratively added to the top layer of build material to build up a 3D object layer by layer. The build material may be, for example, in the form of a powder or granulate, and may be formed from plastic, metal, or any material. In one example, the overhead lamps provide heat energy to the build material during the build process.

In commercially available 3D printers, a pre-heating lamp array may be provided to apply heat to the build material in a build chamber, and a set of lamps may be arranged to approximate uniform irradiance across the chamber. It is assumed in such commercially available 3D printers that the surface temperature of the build material would be proportional to the energy radiated from the lamp array. However, in such commercially available 3D printers, at the pre-heating stage of the 3D printing process and during printing, build chambers may exhibit non-uniform thermal losses, which can lead to temperature variations that affect the quality of manufactured parts.

The present disclosure provides a heating lamp assembly that can apply heat to a build chamber of an additive manufacturing apparatus at a higher energy density at an edge of the build chamber relative to the heat applied to the centre of the build chamber. The heating lamp assembly may comprise a plurality of first lamps (for example, infra-red lamps) oriented to apply heat at a higher energy density at the perimeter of the build chamber. The inventors have determined that heat can be applied to the build chamber in an intentionally non-uniform manner by the heating lamp assembly, to compensate for heat losses from the periphery of the chamber and from the heated build material, thereby to achieve substantially uniform heating of build material when a layer of material is being formed in the build chamber.

In some examples, the heating lamp assembly may comprise an outer boundary portion and an inner portion, the outer boundary portion comprising the plurality of first lamps, and the inner portion comprising at least one second lamp to apply heat to the centre of the build chamber. The heat lamp assembly may be fixed over a build chamber that comprises the build platform, and the first lamps may be utilized to ensure that a greater heat density is provided to a corresponding outer boundary portion of the build chamber compared to a central portion of the build chamber.

The plurality of first lamps that can also be considered a first group of lamps may be aligned with a perimeter boundary of the heating lamp assembly to provide heat energy substantially along an edge of a build surface within the build chamber. A plurality of second lamps forming a second group of lamps can be arranged in a central portion of the assembly to provide heat energy to a central portion of the build chamber.

In some examples, a heating lamp assembly may comprise a plurality of heating lamps to apply heat to a build surface within a build chamber of an additive manufacturing system, when the heating lamp assembly is integrated within the overall additive manufacturing system, the assembly including a first group of lamps of the plurality of heating lamps to apply more heat substantially around a periphery of the build chamber compared to a middle region of the build chamber. Although the lamp assembly as described above can be integrated within an additive manufacturing system, a build unit that includes the build chamber and heater assembly may be separable from other parts of the manufacturing system. The first group of heating lamps of the plurality of lamps may be positioned to apply more heat substantially along an edge of the build chamber than a second group of the lamps of the plurality of heating lamps that are positioned to apply heat to the middle of the build chamber, when the build chamber is located below the heating lamp assembly.

The heating lamp assembly can be utilized with various additive manufacturing techniques or systems such as 3D printing systems. The 3D printing devices may selectively deliver build material and a print agent to a build area within a build chamber of the printing system. One type of print agent is a coalescing agent or a fusing agent which modulates energy absorption by a combination of fusing agent and build material. The build material may be a material that may be transformed into the 3D object. The build material may be, for example, a semi-crystalline thermoplastic powder, which may melt and then solidify. In other examples, the build material may include a paste, a gel, a slurry, a granulate, etc. For example, the agent may include a fusing agent that acts as an energy absorber to transfer an increased quantity of applied energy to the second material relative to untreated build material. In an example, the fusing agent may be a liquid material that absorbs radiation applied by an energy source of the additive manufacturing device (e.g., absorbs particular wavelengths of radiation applied from a heat source, which may be within and/or outside of the visible spectrum). The fusing agent may, in an example, be a dark coloured (e.g., black) thermal absorber and/or a colourless thermal absorber (e.g., Ultraviolet (UV) absorbers). In some examples, other print agents may also be used, such as detailing agents that act as cooling agents and/or a moderating agent that modifies a degree of coalescence of the build material.

In some examples, the 3D printing system may include a plurality of heat sources (e.g. overhead heating lamps for pre-heating build material prior to fusing, fusing lamps, infrared lamps, microwave lamps, etc.). Some of the heating sources, such as the fusing lamps, may be located on a carriage that traverses the print bed to apply energy to the print bed and/or the build material. Some of the heating sources, such as the overhead heating lamps for pre-heating the build material, may be mounted to a substantially fixed platform located over the print bed and can form a heating lamp assembly. The heating lamps mounted to the fixed platform can be any type of heating source that can provide heating of build material at a sufficient temperature to enable 3D printing. The heating lamps may be infrared lamps such as halogen lamps. The infrared lamps may have an elongate tubular construction that defines a longitudinal axis of the lamps; and this longitudinal axis can be used for approximate alignment of individual lamps with a respective edge of the heating lamp assembly.

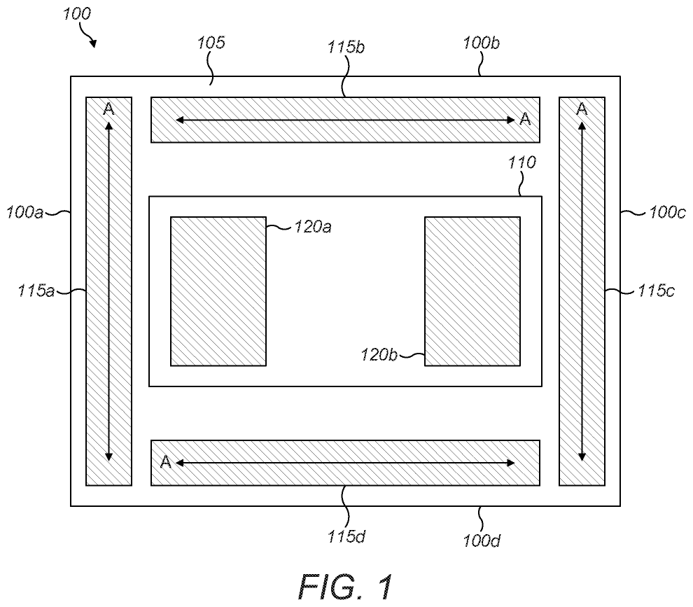

FIG. 1 is a first example of an overhead heating lamp assembly 100 according to the present disclosure, which may be incorporated into a 3D printer. The assembly 100 includes an outer boundary portion 105 and an inner portion 110. In this example, the outer boundary portion 105 extends at least partially around and adjacent an outer periphery of the assembly. The inner portion 110 is in a central part of the assembly adjacent the outer boundary portion 105. The outer boundary portion 105 comprises heating lamp groups 115a, 115b, 115c, 115d that are arranged to provide heat energy to an outer boundary area of a print zone when the assembly is positioned above the print bed. The inner portion 110 comprises heating lamp groups 120a, 120b that are arranged in a central portion of the assembly to provide heat energy to a central portion of a print zone when the assembly is positioned above the print bed. The lamp groups 115a, 115b, 115c, 115d, 120a, 120b are shown schematically in a block representation in FIG. 1 and each of the groups may comprise one or more lamps.

The lamps in each heating lamp group 115a, 115b, 115c, 115d in the outer boundary portion 105 may be arranged substantially along and adjacent to a perimeter edge of the assembly 100 and the outer boundary portion of the assembly is aligned with a corresponding boundary portion of a print bed when the assembly is positioned above the print bed. The lamps 115 are configured to heat substantially along the edges of the print bed.

The lamps 115 can be infrared lamps with an elongate tube such that each lamp may have a substantially longitudinal axis A. The axis A of the each lamp 115 may be aligned adjacent and substantially parallel to its nearest edge of the assembly 100. In the example of FIG. 1, the assembly has a generally rectangular shape when viewed from below and has four sides 100a, 100b, 100c, 100d each with a respective edge. The respective edges form a perimeter outer edge of the assembly 100. At least one heating lamp in each heating lamp group 115a, 115b, 115c, 115d adjacent each side 100a, 100b, 100c, 100d edge of the rectangular assembly and the longitudinal axis A of the at least one heating lamp may be substantially parallel the respective side edge of the rectangular assembly.

In some examples, at least one lamp group 115a, 115b, 115c, 115d may comprise at least one lamp arranged adjacent to and covering a substantial portion of a respective side of the assembly. The lamp groups 115a, 115b, 115c, 115d are arranged to focus heat energy from the lamps in the outer boundary portion 105 to a corresponding boundary area of the build chamber. In some other examples, at least some of the lamps that may be positioned adjacent a side of the assembly in the outer boundary portion may be axially aligned with other lamps that are positioned on the same side of the assembly. Further, one or more or all of the lamp groups 115a, 115b, 115c, 115d may have one or more rows of lamps axially aligned adjacent each side in the outer boundary portion.

It should also be noted that, in some examples, the outer boundary portion may only extend along fewer than all the sides of the assembly. For example, in a build chamber which is rectangular in its XY plane, the boundary portion of the build chamber that requires a higher heat energy density may be on two opposing sides of the build chamber rather than all four sides of the build chamber, in which case only two opposing sides of the lamp assembly form part of the outer boundary portion with lamps arranged in an orientation on two opposing sides of the assembly to provide an increased heat energy density relative to the lamps in the inner portion. Other shapes of lamp assembly and build chamber are possible—e.g. a build chamber may have a boundary that is circular in the XY plane.

With the lamps aligned around the periphery of the lamp assembly, a higher heat energy density may be provided from the outer boundary portion relative to the inner portion of the assembly. The increased heat energy density provided by the non-uniform irradiance compensates for the heat loss that can occur near the outer periphery of the build chamber and can provide more uniform heating of the build material across the build chamber and therefore better thermal control of the printing process.

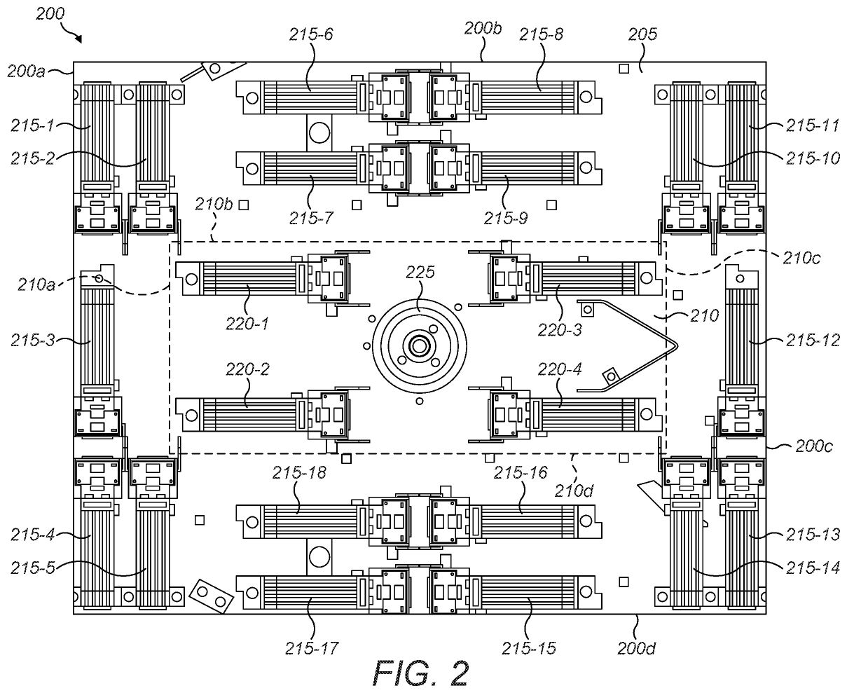

FIG. 2 is a schematic diagram showing an arrangement of a second example of an overhead heating lamp assembly 200 according to the present disclosure. In some examples, the assembly 200 may be utilized with an additive manufacturing system such as a three dimensional (3D) printing system and FIG. 2 is a view of the assembly arrangement from below. The heating lamp assembly 200 may be substantially fixed above a build chamber of the additive manufacturing system and, during a 3D printing process, a build surface within the build chamber may be provided with successive layers of build material such as powder. The lamp assembly 200 is arranged to pre-heat the build material within the build chamber. Similarly to the example of FIG. 1, the lamps in the assembly 200 may apply heat such that, in use, an increased power or heat energy density is provided to the peripheral portions of the build chamber compared to the central portion of the build chamber, thereby compensating for heat energy losses that may occur proximate the edges of the build chamber. Applying heat in a non-uniform manner can achieve uniform heating of a build material within a build chamber that is subject to thermal losses around the edge of the build chamber.

The assembly 200 includes an outer boundary portion 205 and an inner portion 210. In this example, the outer boundary portion 205 extends at least partially around and adjacent the edge boundary of the assembly 200. The inner portion 210 is in a central part of the assembly adjacent the outer boundary portion 205.

The overhead heating lamp assembly 200 may include a plurality of overhead heating lamps 215-1 . . . 215-18 in the outer boundary portion 205 and a plurality of overhead heating lamps 220-1 . . . 220-4 in the inner portion 210 of the assembly 200. In some examples, there may be 22 lamps in total with 18 lamps in the outer boundary portion and 4 lamps in the inner portion. There may be a higher density of lamps in the outer portion than the inner portion, and/or a higher density of lamps around the outer periphery of the outer portion, to achieve non-uniform application of heat to different regions of the build zone. The lamps may include elongate heating members such as elongate tubes and may be infrared lamps such as twin tube, double filament halogen lamps. The infrared lamps may have the same tubular construction such that the lamps have a longitudinal axis and they may be identical i.e. the same size, shape, and power rating. The overhead heating lamp assembly may include a thermal imaging sensor 225 in the inner portion 210. This thermal imaging sensor may be used to monitor temperature within the build chamber and to separately control each of the plurality of heating lamps 215 and 220 or to separately control a subset 215-1 . . . 215-18 of the plurality of heating lamps, based on the monitored temperature, to achieve an approximately uniform temperature across the build chamber, or at least across the upper layer of the build material that includes the current print zone. This may be an optimized temperature for the selected build material. This control can involve switching some lamps on and off at times, or alternatively can involve adjusting the amount of heat radiated by one or more of the lamps. In other examples, the arrangement of the lamp assembly (i.e. their positions and orientations relative to the periphery of the build chamber) achieves more uniform heating across the build chamber or at least the upper layer of the build material that includes the current print zone even without separate thermometric control of individual lamps.

As noted above, a thermal imaging sensor may be used to monitor temperature within the build chamber, and a control unit may be used to control at least one of a plurality of heating lamps separately from at least another one of the plurality of heating lamps based on the monitoring of temperature by the thermal imaging sensor.

A method of heating a print zone of an additive manufacturing system using the above-described apparatus includes use of a heating lamp assembly to apply a higher energy density at a peripheral region of the print zone than at a central region of the print zone. The method may include monitoring temperature within the build chamber and controlling at least one of a plurality of heating lamps of the heating lamp assembly differently from at least another one of the plurality of heating lamps based on the monitoring of temperature. This controlling may involve switching the at least one heating lamp on and off, or adjusting the heat transferred towards a printing bed of the additive manufacturing system, based on the monitoring of temperature.

In the example of FIG. 2, the assembly has a generally rectangular shape when viewed from below and four sides 200a, 200b, 200c, 200d each with a respective edge. The respective edges form a perimeter outer edge of the assembly 200. Each side of the assembly has a plurality of lamps in the outer boundary portion 205 in an orientation to align with a perimeter edge of the assembly 200. In FIG. 2, three lamps 215-1, 215-3, 215-4 are aligned along and adjacent to a first side 200a of the assembly 200 and form a first row of axially aligned lamps. The first row of lamps may be axially aligned adjacent and substantially parallel the first side 200a. Another row of lamps comprising two lamps 215-2, 215-5 may be provided adjacent the first row and within the outer boundary portion of the heating lamp assembly. Two lamps 215-6, 215-8 are aligned along and adjacent to a second side 200b of the assembly 200 and form a second row of axially aligned lamps. The second row of lamps may be axially aligned adjacent and substantially parallel the second side 200b. Another row of lamps comprising two lamps 215-7, 215-8 may be provided adjacent the second row and within the outer boundary portion of the heating lamp assembly nearer the inner portion 210. Three lamps 215-11, 215-12, 215-13 are aligned along and adjacent to a third side 200c of the assembly 200 to form a third row of axially aligned lamps. The third row of lamps may be axially aligned adjacent and substantially parallel the third side 200c. Another row of lamps comprising two lamps 215-10, 215-14 may be provided adjacent the third row and within the outer boundary portion of the heating lamp assembly 200. Two lamps 215-15, 215-17 are aligned along and adjacent to a fourth side 200d of the assembly 200 to form a fourth row of axially aligned lamps. The fourth row of lamps may be axially aligned adjacent and substantially parallel the fourth side 200c. Another row of lamps comprising two lamps 215-16, 215-18 may be provided adjacent the fourth row and within the outer boundary portion of the heating lamp assembly 200.

The inner portion 210 of the assembly is located in a generally central area of the assembly adjacent and within the outer boundary portion 205. The inner portion 210 may approximate a rectangular shape when viewed from below with four sides 210a, 210b, 210c, 210d (shown as dashed lines in FIG. 2). The first side 210a of the inner portion 210 may be parallel to the first side 200a edge of the assembly 200. The second side 210b of the inner portion 210 may be parallel to the second side 200b edge of the assembly 200. The third side 210c of the inner portion 210 may be parallel to the third side 200c edge of the assembly 200. The fourth side 210d of the inner portion 210 may be parallel to the fourth side 200d edge of the assembly 200.

The inner portion 210 may comprise two lamps 220-1, 220-2 adjacent the first side of the inner portion with their longitudinal axis oriented substantially orthogonal to the axis of the lamps 215-1 . . . 215-5 in the outer boundary portion adjacent the first side 200a.

The inner portion 210 may further comprise two lamps 220-3, 220-4 adjacent the third side of the inner portion with their longitudinal axis oriented substantially orthogonal to the axis of the lamps 215-10 . . . 215-15 in the outer boundary portion adjacent the third side 200c.

Viewed from another perspective, the orientation of the lamps in the inner portion is such that two lamps 220-1, 220-3 are axially aligned adjacent the axis of the second side of the inner portion 210 and the two lamps 220-2, 220-4 are axially aligned adjacent the fourth side of the inner portion 210. Each of the four lamps 220-1 . . . 220-4 may be located at a corner of the inner portion.

The lamps in the lamp assembly 200 that are arranged and oriented as in FIG. 2 can be controlled to emit heat energy in a non-uniform manner. Other arrangements of lamps can achieve an equivalent effect—for example an arrangement of lamps including a higher concentration of lamps around a periphery of the lamp assembly than in a central region, for non-uniform application of heat across a circular build chamber.

The arrangement and alignment of the lamps substantially parallel to the side edges of the assembly and all around the outer boundary portion of the assembly can lead to an increased power or heat energy density around the periphery of a build chamber that is located below the lamp assembly 200 compared to lamps in the inner region, to compensate for heat losses that may occur around the edges of the build chamber. There are higher heat losses from the build material closer to the edges of the build chamber, when the external environment is at a lower temperature than the inside of the build chamber, due to the heat loss mechanisms of conduction, convection and radiation. The conduction coefficient between the walls of the build chamber that are typically formed of aluminium and the build material that may be powder is higher than in those areas such as more central areas that are surrounded entirely by powder. Additionally, convection and radiation effects can lead to a higher rate of cooling around the periphery. In some examples, the lamp assembly 200 can improve the dimensional accuracy of a printed object and in particular can reduce variability along the Z-axis perpendicular to the surface of the build surface for those parts printed closer to build chamber edges. This is explained below in more detail with reference to an example 3D printing test.

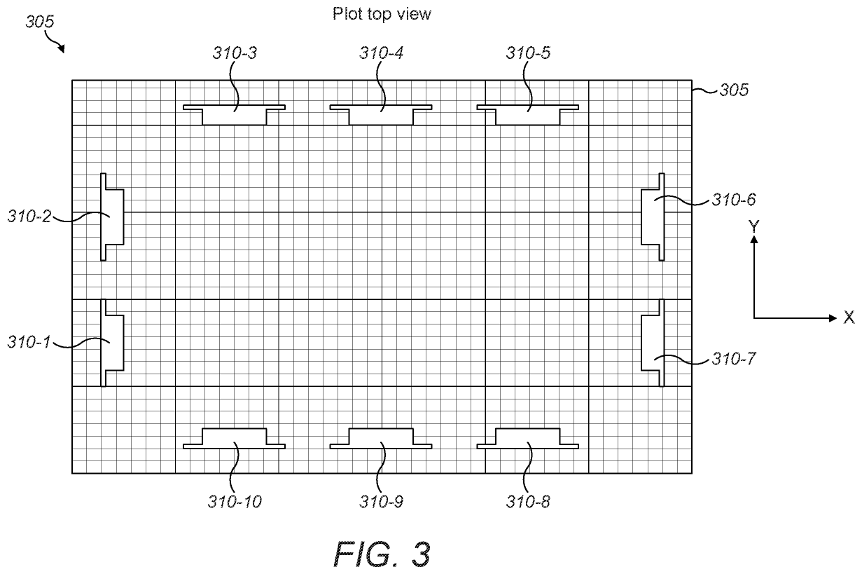

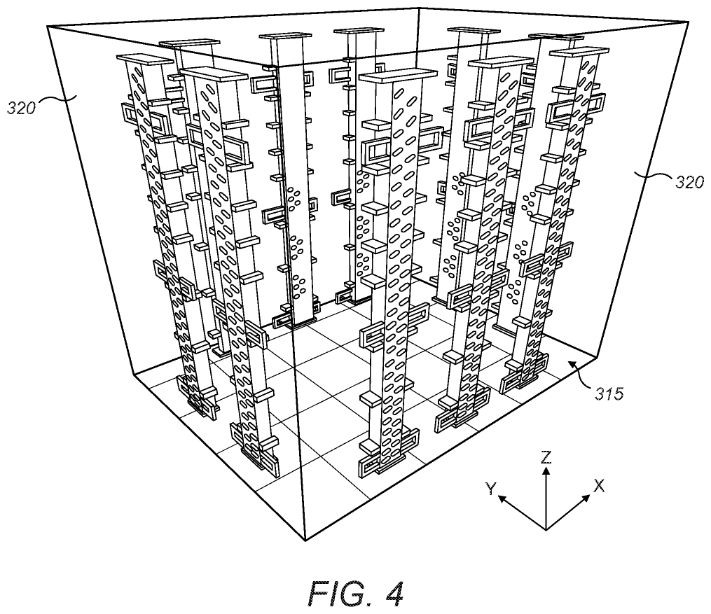

In the example of FIG. 3, a top view of a print bed 300 is shown. In the test, a plurality of column parts 310-1 . . . 310-10 such as shown in FIG. 4 were printed near the perimeter 305 of the build chamber. The build chamber has an X and a Y axis as shown in FIG. 3. The build chamber defines a volume in which objects can be built. A build platform supports printer nozzles and is moveable within the build chamber to add a layer of build material at a current print zone on the top layer of build material. Heat may be applied by a heating lamp assembly such as that in FIG. 1 or FIG. 2. FIG. 4 shows a perspective view of the build chamber of FIG. 3 with sample column parts having been printed near the perimeter of the build chamber 300. These column parts are designed as tall thin columns with lateral fins, both to facilitate test measurements and to emphasize any variations in the Z direction. This perspective view shows the X, Y and Z axis of the build chamber. As is shown, the build volume of build chamber 300 is defined by a generally rectangular base 315 and four side walls 320 upstanding from the base 315. The columns 310-1 . . . 310-10, once formed, extend upwards from the build chamber base 315. In this example, the columns have been additively manufactured in layers using a system comprising the overhead heating lamp assembly as shown in the example in FIG. 2. For the print reliability test, a first measurement along the Z-axis is taken from the bottom of the column to the first fin; a second measurement is taken from the bottom part of the column to the second fin; and the process is repeated until all the fins are measured with respect to the bottom part of the column. This is repeated for all the printed columns in the build chamber. These measured distances for each manufactured column are then compared with nominal values from the original 3D print instruction file to identify any variations. The test includes calculating the deviation from nominal values for every dimension of each column, with the particular focus on deviations in the Z dimension between the real measured values and the nominal values. Such measurements can be used in a calibration and correction procedure, and in the control of manufacturing tolerances, to optimize the additive manufacturing process. However, the test is also valuable for the specific purpose of identifying variations that result from non-uniform heating. Test measurements were carried out and verified that the variability along the Z-axis of the column parts printed near the perimeter 305 and side walls 320 of the build chamber was lower using the new heating assembly described herein, in this 3D printing test, than when using a conventional lamp arrangement. A first measurement was obtained by taking the measurement from the bottom part of the column to the first fin; a second measurement was obtained measuring the bottom part of the column to the second fin; and the process was repeated until all the fins were measured with respect to the bottom part of the column. The same procedure was repeated for all the columns printed in the build chamber. Distances measured along the Z axis, and these and other measurements were compared with the nominal values from the original 3D file that was sent to the printer, and the deviation was calculated for every dimension of each column. Using the lamp assembly 200 to achieve more uniform heating via intentionally non-uniform irradiance, the variability of the Z dimension as between the different columns was found to be relatively low and less than with uniform application of heat. Furthermore, the dimensions for each column are closer to the nominal value of the print instruction, regardless of position in the build chamber. This combination of greater accuracy and reduced variability enables a potential dimensional correction for the column parts for each layer as the parts are built. That is, when correction factors are applied, the same correction factor is applied for each layer. With the use of the heating lamp assembly 200, the relative deviations are similar for each column and therefore a common dimensional correction can be applied at each layer.

In addition to the examples described in detail above, the skilled person will recognize that various features described herein can be modified and/or combined with additional features, and the resulting additional examples can be implemented without departing from the scope of the system of the present disclosure, as this specification merely sets forth some of the many possible example configurations and implementations for the claimed solution.

1. An additive manufacturing system, comprising:
a heating lamp assembly to apply heat to a build chamber at a higher energy density at a peripheral region of the build chamber relative to a central region of the build chamber.

2. The additive manufacturing system of claim 1, wherein the heating lamp assembly comprises a plurality of first lamps aligned with and proximate to a periphery of the heating lamp assembly, to apply heat at the peripheral region of the build chamber.

3. The additive manufacturing system of claim 2, wherein the heating lamp assembly comprises an outer boundary portion and an inner portion, the outer boundary portion comprising the plurality of first lamps and the inner portion comprising at least one second lamp to apply heat to the central region of the build chamber, wherein the plurality of first lamps of the outer boundary portion are to apply heat at the peripheral region of the build chamber with a greater energy density than the at least one second lamp applies heat to the central region of the build chamber.

4. The additive manufacturing system of claim 3, wherein the spacing between each of the plurality of first lamps of the outer boundary portion is less than the spacing between lamps of the inner portion.

5. The additive manufacturing system of claim 3, wherein the outer boundary portion of the heating lamp assembly is substantially aligned with a corresponding outer boundary portion of the build chamber, when the build chamber is installed in the system.

6. The additive manufacturing system of claim 2, wherein each of the plurality of first lamps has a longitudinal axis that is aligned parallel with a nearest edge of the heating lamp assembly.

7. The additive manufacturing system of claim 2, wherein the heating lamp apparatus comprises a plurality of second lamps to apply heat to the central region of the build chamber.

8. The additive manufacturing system of claim 1, wherein the system is to receive a build chamber and the heating lamp assembly is positioned above the build chamber, when installed, to pre-heat the build chamber before additive manufacturing.

9. The additive manufacturing system of claim 8, wherein the heating lamp assembly has a first, second, third and fourth side to form a perimeter of the assembly that substantially aligns with a perimeter of a four-sided build chamber, when installed, wherein the plurality of first lamps includes at least one lamp to align parallel and adjacent to each respective side of the assembly.

10. The additive manufacturing system of claim 3, wherein each of the plurality of first lamps and second lamps are equivalent lamps.

11. A heating lamp assembly, for applying heat to a build chamber of an additive manufacturing system, wherein the heating lamp assembly is configured to apply heat with a higher energy density at a peripheral region of the build chamber than at a central region of the build chamber.

12. A heating lamp assembly according to claim 11, comprising a first plurality of heating lamps aligned with and proximate to a periphery of the heating lamp assembly.

13. A heating lamp assembly according to claim 12, wherein the first plurality of heating lamps is positioned to apply heat at a peripheral region of the build chamber with a greater heat density than a second plurality of heating lamps that are positioned to apply heat to the central region of the build chamber.

14. A heating lamp assembly according to claim 11, further comprising a thermal imaging sensor to monitor temperature within the build chamber.

15. A heating lamp assembly according to claim 14, further comprising a control unit to control at least one of a plurality of heating lamps separately from at least another one of the plurality of heating lamps based on the monitoring of temperature by the thermal imaging sensor.
